(19) United States
(12) Patent Application Publication
(10) Pub. No.: US 2004/0026673 A1
(43) Pub. Date: Feb. 12, 2004

(54) Method for mounting a cable drum flange, means therefor and resulting flange

(76) Inventor: Jean-Pierre Orzel, Auberchicourt (FR)

Correspondence Address: Miles & Stockbridge, Suite 500, 1751 Pinnacle Drive, Mc Lean, VA, 22102-3833, US

(21) Appl. No.: 10/432,260

(22) PCT Filed: Oct. 22, 2001
(86) PCT No.: PCT/FR01/03278

(30) Foreign Application Priority Data
Nov. 22, 2000 (FR) 00/15083

(51) Int. Cl. B66F 1/00

(52) U.S. Cl. 254/1

(57) ABSTRACT

The invention relates to a method for assembling a cable drum flange constituted by a set of wooden sectors (2A) placed side by side to form a disk and a U-shaped rim (4).

This method is characterized in that, to form the flange, it consists in:

closing the rim (4),

positioning the sectors one after the other so that the outer end is fitted into the channel of the rim,

prior to inserting the last sector, exerting a force on the set of assembled sectors in the plane of the disk in order to compress the sectors and clear a free space with an angle greater than that of the sector to be inserted,

then fitting the outer end of the last sector into the channel of the rim, followed by the inner end, and

as soon as possible after the outer end of the last sector has been fitted, releasing the compression.

Clean Copy of Specification only of application Ser. No. ______, filed May 21, 2003, in the name of Jean-Pierre ORZEL, based on PCTFR01/03278.

### FIELD OF THE INVENTION

The invention relates to a method for assembling a cable drum flange.

It also relates to the means for implementing the method and to the cable drum flange thus obtained.

### BACKGROUND OF THE INVENTION

A known method for transporting electrical cable or conduit is to wind-it onto cable drums.

Conventionally, a cable drum is constituted by a cylinder and two flanges.

There are known cable drums made of wood (CH-A-415225) wherein the cylinder is constituted by a juxtaposition of wooden planks disposed so as to constitute a cylindrical wall and the ends of these planks are fitted grooves formed in the inner faces of the flanges.

Tie rods or bars act on the flanges to hold the barrel in place with a clamping action.

The flanges themselves are each constituted by two layers of wooden boards disposed crosswise and nailed to one another.

These boards must be shaped at each end to define the circumference of the flange.

It is also possible to place, around the flange, a rim of U-shaped cross-section forming a tread, and to replace the wooden cylinder with a metal cylinder, as in the cable drum described in the document GB-A-2173171.

In that example, the cylinder is positioned relative to the flanges by means of pieces projecting from the inner faces of the flanges.

These modifications do not really improve the load strength of the drum, and quickly result in a need to tighten the tie rods, the consequence of which is to deform the flange.

There is also the problem of the quantity of nails required to assemble the two layers of board and the difficulty of driving them home for high-capacity cable drums using thick boards.

The rim of U-shaped cross-section is placed on these drums after the wooden flange has been assembled.

It is then permanently closed by a weld done from the outside.

A drum has recently appeared that, to form the flange, uses sectors disposed side by side, which are held in place internally by a center tube and externally by a rim of U-shaped cross-section added after the sectors have been put in place.

Such a flange has improved load strength properties.

The object of the invention is to improve this type of cable drum.

To this end, the subject of the invention is a method for assembling a cable drum flange constituted by a set of wooden sectors placed side by side to form a tight disk and a U-shaped rim, this method being characterized in that it consists in:

closing the rim,

positioning the sectors, one after another, so that the outer end is fitted into the channel of the rim,

prior to inserting the last sector, exerting a force on the set of assembled sectors in the plane of the disk in order to compress the sectors and clear a free space with an angle greater than that of the sector to be inserted,

then fitting the outer end of the last sector into the channel of the rim, followed by the inner end, and

as soon as possible after the outer end of the last sector has been fitted, releasing compression.

The other subjects of the invention are the means for implementing the method and the cable drum flange thus obtained.

### BRIEF DESCRIPTION OF THE DRAWINGS

The invention will be clearly understood with the help of the description below, given as a nonlimiting example, in reference to the attached drawing, which schematically represents:

FIG. 1: a view of a cable drum,

FIG. 2: a view of a detail of a cable drum flange sector,

FIG. 3: a detail of the assembly of the flange,

FIG. 4: a diagram of the assembly of the cable drum flange,

FIG. 5: a sectional view along A-A in FIG. 4,

FIG. 6: another diagram of the assembly seen from above,

FIG. 7: the assembly diagram of FIG. 6 in vertical section.

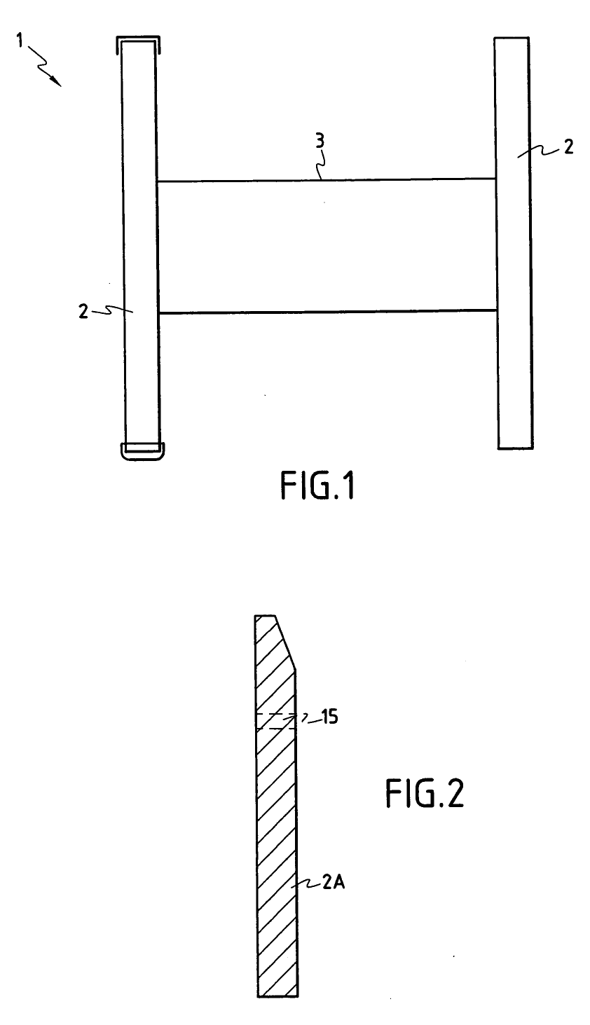

Referring to the drawing, we see a cable drum 1.

Conventionally, this cable drum comprises two flanges 2, between which runs a barrel 3, preferably made of metal.

### DESCRIPTION OF THE PREFERRED EMBODIMENTS

The cable drum flange is formed by a set of wooden sectors 2A placed side by side so as to form a disk and a U-shaped rim having an inward facing channel.

The outer ends of the sectors are fitted into the channel of this rim 4.

For good strength and durability, it is necessary that there be no functional play between the sectors so that they are butt-jointed.

This prevents, in particular, the penetration of water.

Lastly, after the flanges are mounted on the barrel, the middle part of the flange is clamped between two cover plates 5.

A center tube 6 forms, with the two cover plates 5, a hub that clamps the center part of the flange, which prevents it from deforming into a conical shape when the tie rods act to join the flanges and the barrel.

These tie rods (not represented) are located at a distance from the center axis of the barrel having a value less than that of the radius of the barrel.

The flange 2 is advantageously formed of a single layer of sectors 2A, whose thickness is chosen based on the desired strength.

The use of a single layer of sectors is extremely conducive to the durability of the cable drum.

According to the invention, forming the flange consists in:

closing the rim 4,

positioning the sectors one after the other so that the outer end is fitted into the channel of the rim,

prior to inserting the last sector, exerting a force on the set of assembled sectors in the plane of the disk in order to compress the sectors and clear a free space with an angle greater than that of the sector to be inserted,

then fitting the outer end of the last sector into the channel of the rim, followed by the inner end, and

as soon as possible after the outer end of the last sector has been fitted, releasing the compression.

This method makes it possible to join both edges of the rim on the inside and on the outside of the channel, so as to give the assembly excellent strength.

In essence, previously, it was only possible to weld the rim on the outside.

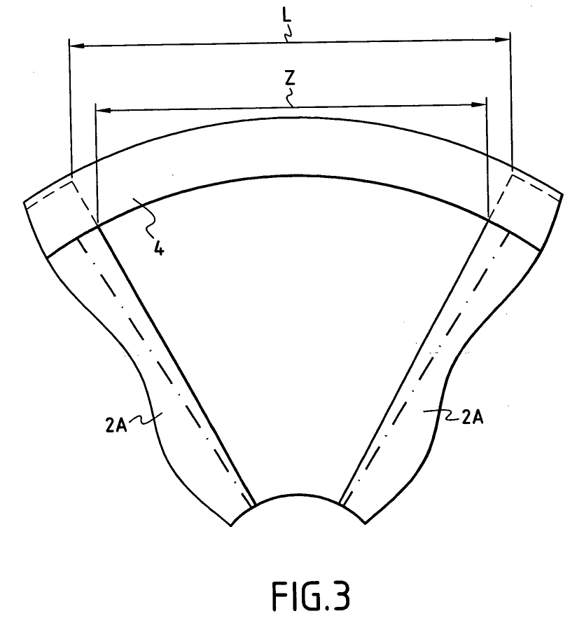

In fact, as may be seen in FIG. 3, when inserting the last sector into the channel, it becomes clear that the length L of the chord of this sector is greater than the chord Z running through the inner edge of the rim, and the two sides of the unclosed disk delimit the free space.

This difference theoretically makes it impossible to insert the last sector given the lack of play in the assembly.

However, when compression forces are exerted, the elasticity of the wood is enough to gain the few millimeters that allow the last sector to be inserted.

The position of the sectors during the compression is represented by a dot-and-dash line.

Thus, when the last sector 2A is put in place, the spring back of the rest of the sectors wedges the last sector in place.

Advantageously, the size of the sectors is determined so that the sum of the angles of said sectors is greater than 2π, in order to produce, after the insertion of said sectors, a wedging effect.

This wedging contributes, in particular, to preventing the admission of water, which is a factor that can degrade the cable drum.

In one mode of assembly, compression is exerted on the assembled sectors by pressing on the lateral faces of the sectors framing the last free space.

In a variant of assembly, a bore 15 is produced in the thickness of the two sectors framing the space into which the last sector must be inserted (FIG. 2).

A pin is inserted into each of the bores, and the pins are moved apart so as to clear enough space for the insertion of the last sector.

In a third variant, the two sectors framing the free space are grasped and pulled apart.

The means for implementing the method according to the first variant comprise:

a pre-closed rim 4 of U-shaped cross-section,

a support table 10,

means for positioning the rim on this support table,

means for positioning the center part of the flange to be formed and

means 100 for exerting a force on the set of assembled sectors in the plane of the disk, in order to compress the sectors and clear a free space with an angle greater than that of the last sector to be inserted.

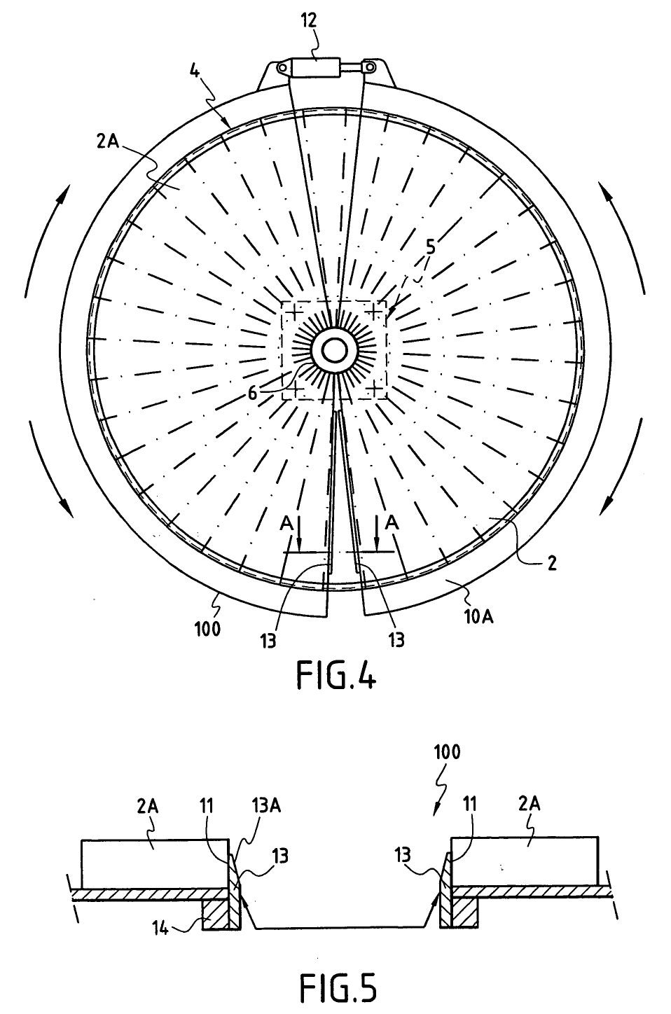

In the embodiment of FIGS. 4 and 5, the support table 10 is formed of two sectors 10A, 10B rotatable around an axis that is the same as that of the flange, with each sector being defined by an angle of less than 180°.

Each sector 10A, 10B of the table has a stop 11 against which rests, for example, the edge of the sector framing the space into which the last sector must be inserted, and a drive means 12 moves the stops toward and away from one another.

Each stop 11 is formed by one of the two opposing sides of a plate 13 attached to the support table.

The side 13A of the plate facing the space that must receive the last sector is beveled.

The height of the blade relative to the supporting surface is preferably less than the thickness of the sectors.

When the last sector has been inserted by its outer part, a tap with a hammer is enough to position it correctly in the required place.

At least the outer end of the last sector will advantageously be trimmed to locally reduce its thickness so that it can be more easily inserted into the channel.

In particular, when the plate bearing the stop is placed against the edge of the sector, a piece 14 can be mounted underneath the support table in order to spread the force over a larger surface area during the compression.

The length of the blade is significant, on the order of three quarters of the length of the radius of the flange, in order to locally reduce the pressure.

The speed of assembly is increased, making it possible to obtain cable drum flanges that are nail-free and very strong.

This results in a cable drum flange formed of a plurality of sectors and a U-shaped rim that is pre-closed by a weld seam, particularly an internal one.

In essence, this method of assembly makes it possible to weld the U-shaped rim on the inside and on the outside in order to obtain increased strength.

It would even be possible to weld a reinforcing strip to the inside of the U-shaped rim, which was impossible before.

In the second variant of assembly, the plates 13 are replaced by pins that are fitted into holes in the sectors.

In this case, the means 100 comprise two pins and a drive means for moving the two pins apart.

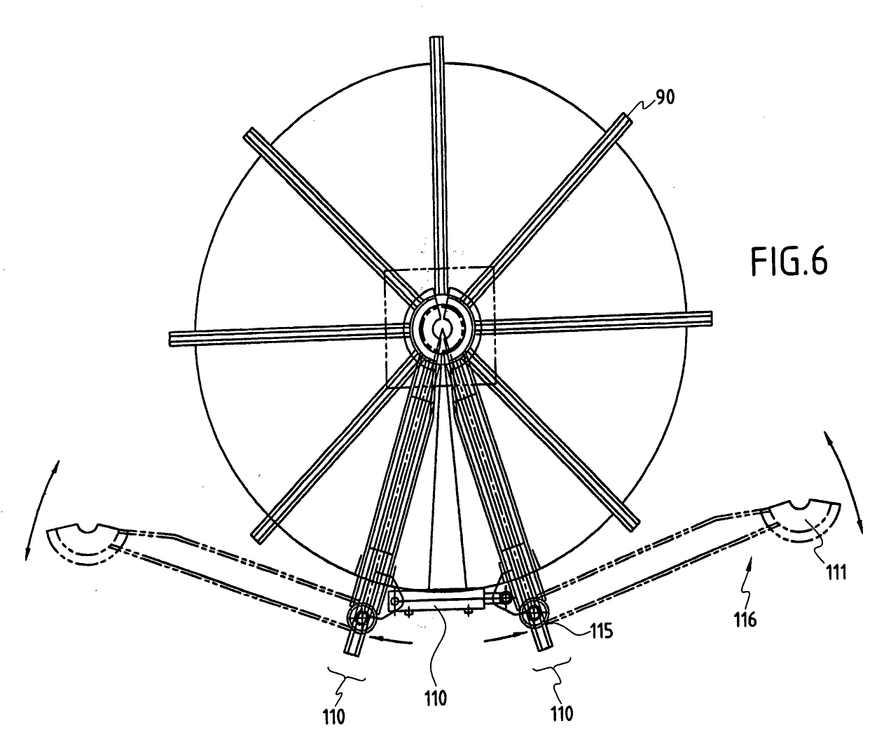

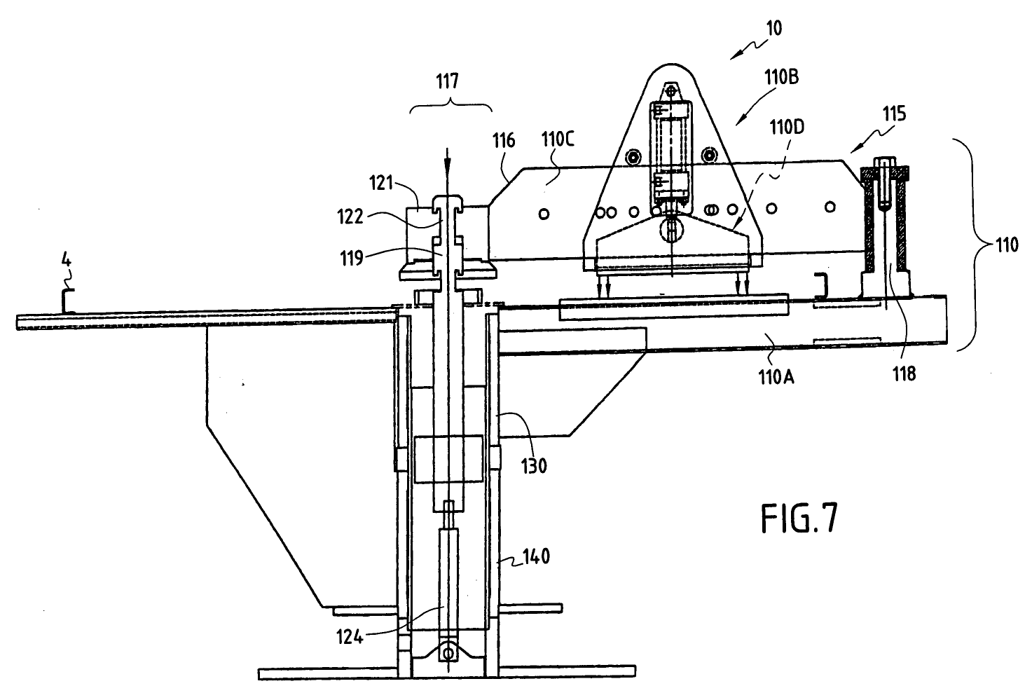

In the variant of embodiment of FIGS. 6 and 7, the support table 10 is composed of several radial arms 90.

One group of arms is rigidly mounted on a cylinder 130 and the other group is mounted on a second cylinder guided around a common axis of rotation.

The means 100 for exerting a force in order to compress the sectors comprise two clamps 110 for gripping the end sectors and a means 120 for moving at least one clamp relative to the other so as to move them apart.

The clamps 110 are each constituted by two jaws 110A, 110B, a lower jaw 110A being in the form of a lower arm 110A.

One of the parts, and particularly its lower arm, is borne by a cylinder 130, and the other is borne by a second cylinder 140 coaxial to the first, the cylinders being rotatable relative to one another.

An upper jaw 110B is disposed above each lower jaw 110A.

To form the clamp 110, the upper jaw 110B is formed of a bracket 110C and a vertically moving clamping piece 110D.

Each upper jaw is articulated at one 115 of its ends 115, 116 so that it can be moved away for the removal of the flange, and the other end 116 includes a means 117 for fast coupling at least indirectly with the lower jaw.

According to the embodiment represented, the articulation 118 of the upper jaw 110B occurs with the distal end of the lower jaw 110A, and the fast coupling of the end 116 occurs with a center piece 119 coaxial to the cylinders.

The open position of the upper jaws is represented by dot-and-dash lines.

For the fast coupling, the end of the corresponding upper jaw includes a piece 121 in the form of a disk portion, which fits around a bolt 122.

The coupling of the bolt takes place by means of a groove and a rib.

This bolt can be maneuvered by means of a screw jack 124 housed in the cylinders.

The clamps are moved relative to one another for example by a screw jack 120 borne on each lower arm of the clamp.

In FIG. 6, we see that the pieces 121 in the form of disk portions extend over a sector of less than 180° in order to allow the rotation

While this invention has been described in conjunction with specific embodiments thereof, it is evident that many alternatives, modifications and variations will be apparent to those skilled in the art. Accordingly, the preferred embodiments of the invention as set forth herein, are intended to be illustrative, not limiting. Various changes may be made without departing from the true spirit and full scope of the invention as set forth herein.

1. Method for assembling a cable drum flange constituted by a set of wooden sectors (2A) placed side by side to form a disk and a U-shaped rim (4), this method being characterized in that, to construct the flange, it consists in:
closing the rim (4),
positioning the sectors one after the other so that the outer end is fitted into the channel of the rim,
prior to inserting the last sector, exerting a force on the set of assembled sectors in the plane of the disk in order to compress the sectors and clear a free space with an angle greater than that of the sector to be inserted,
then fitting the outer end of the last sector the channel of the rim, followed by the inner end, and
as soon as possible after the outer end of the last sector has been fitted, releasing the compression.

2. Method according to claim 1, characterized in that the size of the sectors is determined so that the sum of the angles of said sectors is greater than 2π in order to produce, after the insertion of said sectors, a wedging effect.

3. Method according to claim 1, characterized in that compression is exerted on the assembled sectors by pressing on the lateral faces of the sectors framing the last free space.

4. Method according to claim 1, characterized in that a bore (15) is produced in the thickness of the two sectors framing the space into which the last sector must be inserted, and a pin is inserted into each of the bores, and the pins are moved apart in order to clear enough space for the insertion of the last sector.

5. Method according to claim 1, characterized in that the two sectors framing the free space are grasped and pulled apart.

6. Means for implementing the method according to any of claims 1 through 5, characterized in that they comprise:
a pre-closed rim (4) of U-shaped cross-section,
a support table (10), and
means (100) for exerting a force on the set of assembled sectors in the plane of the disk, in order to compress the sectors and clear a free space with an angle greater than that of the last sector to be inserted.

7. Means according to claim 6, characterized in that:
the support table (10) is formed of two sectors (10A, 10B) rotatable around an axis that is the same as that of the flange, with each sector (10A, 10B) being defined by an angle of less than 180°,
each sector (10A, 10B) of the table carries a stop (11) against which rests, for example, the edge of the sector framing the space in which the last sector must be inserted and
a drive means (12) moves the stops toward and away from one another.

8. Means according to claim 6, characterized in that the means (100) comprise two pins and a drive means for moving the two pins apart.

9. Means according to claim 7, characterized in that each stop (11) is formed by one of the two opposite sides of a plate (13) attached to the support table.

10. Means according to claim 6, characterized in that the means (100) for exerting a force in order to compress the sectors comprise two clamps (110) for grasping the end sectors and a means (120) for moving at least one clamp relative to the other so as to move them apart.

11. Means according to claim 10, characterized in that the clamps are moved relative to one another by a jack screw (120) supported on each lower arm of the clamp.

12. Means according to claim 10, characterized in that:
the clamps (110) are each constituted by two jaws, one lower (110A) and the other upper (110B),
one of them (110A) is borne by a cylinder (130) and the other is borne by a second cylinder (140) coaxial to the first, the cylinders being rotatable relative to one another.

13. Means according to claim 12, characterized in that each upper jaw is articulated at one (115) of its ends (115, 116) to the corresponding lower jaw so that it can be moved away for the removal of the flange.

14. Means according to claim 13, characterized in that the articulation (118) of the upper jaw (110B) occurs with the distal end of the lower law (110A).

15. Means according to claim 12, characterized in that one (116) of the ends includes a means for fast coupling at least indirectly with the lower arm.

16. Means according to claim 15, characterized in that the fast coupling occurs with a center piece (119) coaxial to the cylinders.

17. Means according to claim 16, characterized in that, for the fast coupling, the end of the corresponding upper jaw includes a piece (121) in the form of a disk portion, which fits around a bolt (112).

18. Cable drum flange obtained by the method according to any of claims 1 through 5.
